(19) United States
(12) Patent Application Publication
(10) Pub. No.: US 2012/0191288 A1
(43) Pub. Date: Jul. 26, 2012

(54) ON-BOARD DIAGNOSTICS SYSTEM AND METHOD

(75) Inventors: Gongshin Qi, Troy, MI (US); Wei Li, Troy, MI (US); Steven J. Schmieg, Troy, MI (US); David B. Brown, Brighton, MI (US); Paul M. Najt, Bloomfield Hills, MI (US)

(73) Assignee: GM GLOBAL TECHNOLOGY OPERATIONS LLC, DETROIT, MI (US)

(21) Appl. No.: 13/011,668

(22) Filed: Jan. 21, 2011

(51) Int. Cl. F01N 11/00; B01J 35/02; B01J 23/30; B01J 21/04; B01J 21/06; B01J 23/83; B01J 29/00; B01J 23/10

(52) U.S. Cl. 701/29.1; 502/100; 502/304; 701/29.4

(57) ABSTRACT

An on-board diagnostics system and method are disclosed for a vehicle having an engine and an exhaust system. The system includes a modified selective catalytic reduction catalyst coupled to the engine via the exhaust system, where the modified selective catalytic reduction catalyst includes oxygen storage components. An upstream oxygen sensor is disposed in the exhaust pipe upstream of the modified selective catalytic reduction catalyst and a downstream oxygen sensor is disposed in the exhaust pipe downstream from the modified selective catalytic reduction catalyst. An engine control module receives data from the upstream and downstream oxygen sensors and determines a lifespan of the modified selective catalytic reduction catalyst based upon the data from the upstream and downstream oxygen sensors.

### TECHNICAL FIELD

The present disclosure relates generally to an on-board diagnostics system and method.

### BACKGROUND

Systems, including those having gas turbine exhaust or lean burn engines, often include selective catalytic reduction (SCR) catalysts to reduce nitrogen oxide (NOₓ) emissions. SCR catalysts are used in conjunction with a gaseous reductant, such as an ammonia- or urea-based reducing agent. On-board diagnostics of selective catalytic reduction catalyst systems are currently performed using NOₓ sensors. In particular, NOₓ sensors are utilized upstream and downstream of the selective catalytic reduction catalyst to measure NOₓ concentrations before and after the SCR catalyst. However, the effectiveness of NOₓ sensors to perform on-board diagnostics can suffer as a result of ammonia slip, i.e., ammonia passing through the SCR unreacted, due, in part, to the interference between the unreacted ammonia and the NOₓ in the exhaust.

### SUMMARY

An on-board diagnostics system and method are disclosed for a vehicle having an engine and an exhaust system. The system includes a modified selective catalytic reduction catalyst coupled to the engine via the exhaust system, where the modified selective catalytic reduction catalyst includes oxygen storage components. An upstream oxygen sensor is disposed in the exhaust pipe upstream of the modified selective catalytic reduction catalyst, and a downstream oxygen sensor is disposed in the exhaust pipe downstream from the modified selective catalytic reduction catalyst. An engine control module receives data from the upstream and downstream oxygen sensors and determines a lifespan of the modified selective catalytic reduction catalyst based upon the data from the upstream and downstream oxygen sensors.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A and 1B are graphs which together illustrate a thermal relationship between oxygen storage components and SCR catalyst degradation, where FIG. 1A shows CO₂ production versus average catalyst temperature for oven aged modified SCR catalysts, and FIG. 1B shows the percent of NOₓ conversion versus average catalyst temperature for the oven aged modified SCR catalysts;

FIG. 1C is a schematic illustration of the gas composition changes throughout the cycles of the CO/O₂ titration;

FIG. 2 is a schematic diagram of an example of the on-board diagnostics system;

FIGS. 3A and 3B are schematic illustrations of examples of the modified SCR catalysts;

FIGS. 4A through 4C are partial cross-sectional and schematic illustrations of examples of the modified SCR catalysts supported by a support body; and

FIGS. 5A and 5B are graphs illustrating one example of how on-board diagnostics are performed using the system and method disclosed herein.

### DETAILED DESCRIPTION

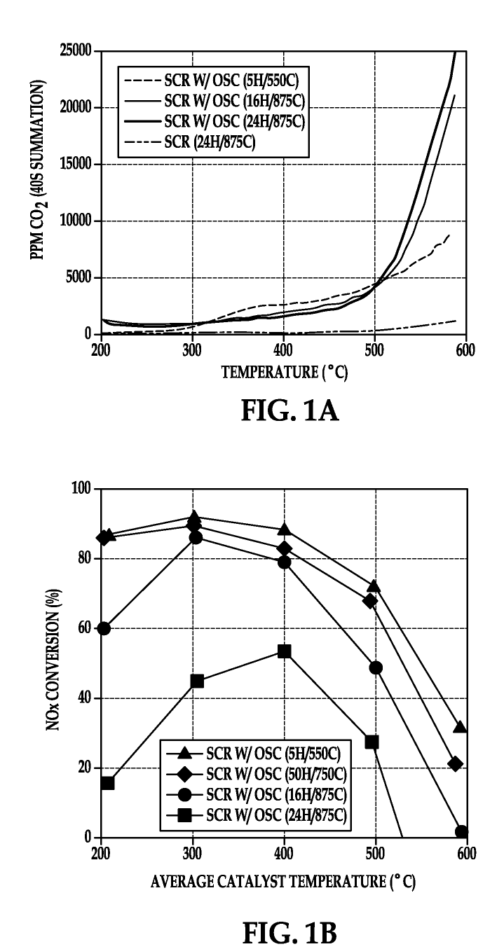

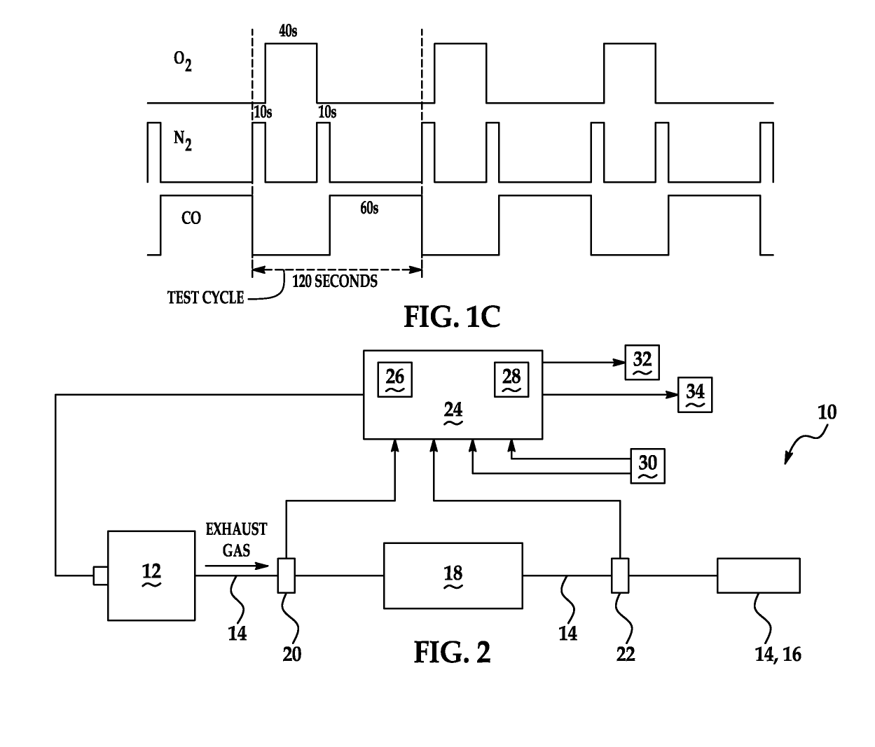

Examples of the system and method disclosed herein are based upon a relationship between oxygen storage capacity of a modified SCR catalyst (i.e., an SCR catalyst including oxygen storage components) and thermal degradation of the modified SCR catalyst. During lab reactor CO/O₂ cycling measurements, it has been found that as a modified SCR catalyst ages, the carbon dioxide production increases as the operating temperature increases. The change in carbon dioxide production indicates that the capability of the modified SCR catalyst to store oxygen is increasing. This is shown in FIG. 1A. It has also been found that as a modified SCR catalyst ages, the percentage of NOₓ conversion decreases. This is shown in FIG. 1B.

FIGS. 1A and 1B illustrate, respectively, lab reactor data of CO/O₂ titration experiments and NOₓ conversion experiments using modified catalysts. To form the modified catalysts, a copper zeolite catalyst was doped with 30 g/L of an oxygen storage component (CeO₂—ZrO₂ mixed oxides with 70% CeO₂ and 30% ZrO₂ from Rhodia Co.) and was oven aged for 5 hours at 550° C., 50 hours at 750° C., 16 hours at 875° C., or 24 hours at 875° C.

CO/O₂ titration was used to test the oxygen storage capacity of the 5 hour, 16 hour, and 24 hour aged modified catalysts. An undoped copper zeolite catalyst was also tested for comparison of the oxygen storage capacity. The CO/O₂ titration test consisted of a repetitive 120 second test cycle (purge system with 100% N₂ for 10 s, oxidize the catalysts with O₂ for 40 s, purge the system again with 100% N₂ for 10 s, and add 2500 ppm CO for 60 s) while the temperature is ramped from 200° C. to 600° C. at a rate of 2° C. per minute for 2 hours. FIG. 1C illustrates how the gas composition changes throughout the cycles of the CO/O₂ titration. Three full 120 second cycles are shown, one of which is labeled “test cycle”. Each cycle includes 40 seconds of O₂ exposure followed by 60 seconds of CO exposure, with 10 second N₂ purges in between the change in gas. In this test, oxygen is stored in the oxygen storage components when the catalyst is exposed to O₂, and when the gas composition is switched to CO, CO reacts with the oxygen stored in the oxygen storage components to form CO₂. Measuring the CO conversion to CO₂ enables one to determine how effectively the catalyst has stored O₂.

The CO₂ production data is a summation of the data recorded over the 60 second time period when the catalyst is exposed to CO at the respective temperatures. As illustrated in FIG. 1A, as the average catalyst temperature was increased to above 500° C. during the test, the CO₂ production increased as the aging severity of the modified catalysts increased. For example, the 24 hour aged modified catalyst produced more CO₂ than the 16 hour aged modified catalyst, and the 16 hour aged modified catalyst produced more CO₂ than the 5 hour aged modified catalyst.

NOₓ conversion was measured for the 5 hour, 50 hour, 16 hour, and 24 hour aged modified catalysts. The steady-state NOₓ conversion measurement was performed with a gas feedstream containing 10% O₂, 5% H₂O, 8% CO₂, 200 ppm NO, and 180 ppm NH₃ at a space velocity of 25,000 h⁻¹. As illustrated in FIG. 1B, the NOₓ conversion (i.e., SCR performance) decreased as the aging severity of the respective modified catalysts increased.

Taken together, this data indicates that the health and lifespan of the SCR catalyst used in the modified SCR catalyst can be monitored by detecting changes in the oxygen storage capacity of the modified SCR catalyst. As such, on-board diagnostics of these modified SCR catalysts may be performed using oxygen sensors as opposed to traditional NOₓ sensors.

An example of a system 10 for performing on-board diagnostics based upon the relationship between the oxygen storage capacity of the modified SCR catalyst and thermal degradation of the modified SCR catalyst is shown in FIG. 2. The system 10 may be utilized in any vehicle having an engine 12 and an exhaust system 14 (which includes an exhaust pipe 16), and which uses an SCR catalyst for NOₓ reduction. In one example, the system 10 is used in a vehicle having a diesel engine.

The engine 12 converts fuel into energy through a series of combustions. In a diesel engine, air is compressed and then fuel is injected. Air heats up when it is compressed, and thus the injected fuel is ignited. The engine 12 is in communication with an engine control module 24 (described further hereinbelow) which transmits signals to deliver precise amounts of fuel and air to the engine 12 at desirable times. The combustion process creates exhaust gases that are passed out of the engine 12 via exhaust system 14.

The system 10 includes a modified selective catalytic reduction catalyst 18. The modified SCR catalyst 18 is coupled to the engine 12 via the exhaust system 14. The modified SCR catalyst 18 includes the SCR catalyst and oxygen storage components.

The exhaust system 14 may include a support body (a partial cross-sectional view of which is shown in FIGS. 4A through 4C, see reference numeral 42) that is used to support the modified SCR catalyst 18. In one example, the support body 42 is a flow-through support body with an inlet that receives the oxygen-rich or oxygen-depleted exhaust flow and an outlet that delivers the exhaust flow from the support body 42. The support body 42 may be a monolithic honeycomb structure that has several hundred (e.g., about 400) parallel flow-through channels (see reference numeral 44 in FIGS. 4A through 4C). The flow-through channels 44 include surfaces 46, 48 over which the exhaust gases flow while passing through the support body 42. The monolithic honeycomb structure may be formed from any material capable of withstanding the temperatures and chemical environment associated with the exhaust flow. Some specific examples of materials that may be used include ceramics such as extruded cordierite, silicon carbide, silicon nitride, zirconia, mullite, spodumene, alumina-silica-magnesia, zirconium silicate, sillimanite, petalite, or a heat and corrosion resistant metal such as titanium or stainless steel. The support body 42 and the various examples of how the support body 42 supports the modified SCR catalyst 18 will be further described in reference to FIGS. 4A through 4C.

The SCR catalyst is a selective catalytic reduction catalyst selected from an oxide-based catalyst or a molecular sieve. Suitable oxide-based catalysts include vanadium oxide or tungsten oxide supported on titania, mixed vanadium-tungsten oxides supported on titania. Suitable molecular sieves include zeolites (i.e., aluminum silicates) or aluminum silica phosphates. Examples of zeolites include Cu/ZSM-5, chabazites (e.g., commercially available SSZ-13), such as copper-based chabazites, or iron-based zeolites. Examples of aluminum silica phosphates include those having the chabazite structure, such as commercially available SAPO-34 (e.g., Cu/SAPO-34).

The oxygen storage components may be any material that exhibits a change in oxygen storage capacity at the conditions to which the modified SCR catalyst 18 is exposed. These conditions may include the temperatures of the exhaust system 14 and the composition of the emissions sent through the exhaust system 14. In one example, the oxygen storage components are selected so that the oxygen storage capacity changes at a rate that is equal to or faster than a rate of degradation of the selected SCR catalyst. For example, the oxygen storage capacity may increase over the exposure time while the NOₓ storage/conversion of the SCR catalyst decreases over the exposure time. Examples of suitable oxygen storage components include CeO₂, metal promoted CeO₂, CeO₂ on an alumina support, and zirconia stabilized CeO₂. It is believed that CeO₂, CeO₂ on an alumina support, or zirconia stabilized CeO₂ may be particularly suitable for systems with upper limit operating temperatures of at least 800° C. It is believed that metal promoted CeO₂ may be particularly suitable for systems with upper limit operating temperatures of less than 800° C. This may be due, at least in part, to the fact that the selected metal sinters at these temperatures, which alters the oxygen storage capacity function of these oxygen storage components.

Metal promoted CeO₂ includes a trace amount (more than zero) of a metal added to the CeO₂. The metal is selected such that it enhances the oxygen storage capacity of the CeO₂ and such that it sinters at the exhaust system 14 operating temperatures. In one example, the metal is copper, iron, tungsten, nickel, or mixtures of these metals. In another example, the trace amount is equal to or less than 20 g/ft³. In yet another example, the trace amount ranges from 1 g/ft³ to 10 g/ft³. In still another example, the trace amount is equal to or less than 1 g/ft³. With metal promoted CeO₂, the mechanism resulting in the oxygen storage capacity increase may be related to the migration of the metal from the SCR catalyst (e.g., the zeolite structure) to the oxygen storage components. If metal migration is occurring, it may be less desirable to utilize metal promoted CeO₂ for the examples disclosed herein.

The oxygen storage components may have any desirable particle size and/or surface area. In one example, the particle size is equal to or less than 15 nm. In another example, the surface area is equal to or greater than 100 m²/g.

The ratio of oxygen storage components to SCR catalyst ranges from about 1:4 to about 1:5. In one example, the oxygen storage component loading is about 30 g/liter and the SCR catalyst loading ranges from about 120 g/liter to about 160 g/liter.

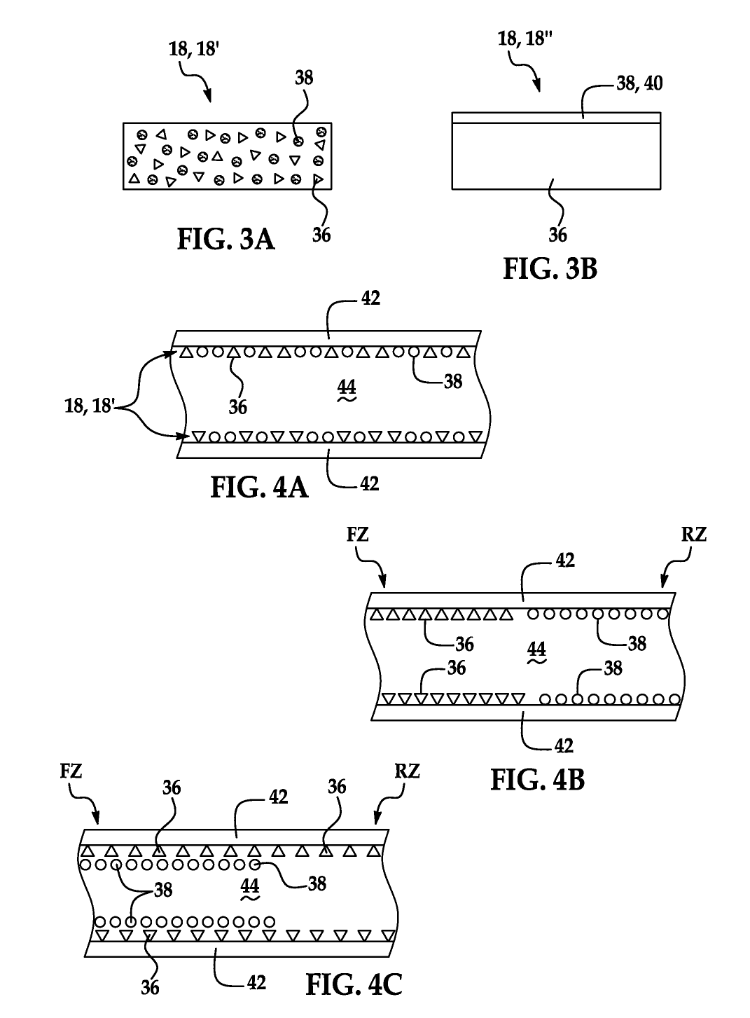

Schematic representations of examples of the modified SCR catalyst 18 (labeled 18′, 18″) are shown in FIGS. 3A and 3B. As shown in these figures, each example of the modified SCR catalyst 18 includes the SCR catalyst 36 and the oxygen storage components 38. FIG. 3A illustrates an example of the modified SCR catalyst 18, 18′ where the oxygen storage components 38 are mixed with the SCR catalyst 36, and thus are substantially uniformly present throughout the modified SCR catalyst 18, 18′. To make this catalyst 18, 18′, any solution based method may be used. For example, a solution of the oxygen storage components 38 may be impregnated into the SCR catalyst 36. FIG. 3B illustrates an example of the modified SCR catalyst 18, 18′ where the oxygen storage components 38 are deposited as a layer on one surface of the SCR catalyst 36. When using deposition, the oxygen storage components 38 may be first ball-milled to form a slurry. The slurry may be maintained at a pH of 5.0 by adding acetic acid or another suitable acid. After ball milling for a predetermined time (e.g., 15 hours to 20 hours), the slurry is washcoated onto a monolith core SCR catalyst (e.g., ¾″×1″ 400 cpsi/4 mil cordierite). In one example, the targeted total washcoat loading is 30 g/L. After washcoating, the monolithic catalyst is dried and calcined at a suitable temperature for a predetermined time (e.g., 550° C. for 5 hrs in static air).

FIGS. 4A through 4C illustrate examples of the modified SCR catalyst 18 being supported by the previously mentioned support body 42. FIG. 4A illustrates an example of the support body 42 having the example of the modified SCR catalyst 18, 18′ (shown in FIG. 3A) uniformly coated on the surfaces thereof. The SCR catalyst 36 and the oxygen storage components 38 are mixed together and the coated across the surfaces of the support body 42. The oxygen storage materials 38 may also be loaded onto the SCR catalyst 36 together with copper. This mixture of materials may be uniformly coated on the surfaces of the support body 42. FIG. 4B illustrates an example of the support body 42 having the SCR catalyst 36 and the oxygen storage components 38 zone-coated on different areas of the surfaces. Zone-coating generally refers to coating different washcoats (e.g., catalyst materials) onto different locations (zones) of a monolithic substrate or support. In the example shown in FIG. 4B, the SCR catalyst 36 is coated near the front zone FZ (i.e., area adjacent the inlet of the flow-through channel 44) and the oxygen storage components 38 are coated near the rear zone RZ (i.e., area adjacent the outlet of the flow-through channel 44). In another example, the oxygen storage components 38 may be deposited in the front zone FZ and the SCR catalyst 36 may be deposited in the rear zone RZ. FIG. 4C illustrates an example of the support body 42 having the SCR catalyst 36 coated across the surfaces thereof (in both zones FZ, RZ), and having the oxygen storage components 38 coated across the SCR catalyst 36 in the front zone FZ alone. Similarly, in another example, the support body 42 may have the SCR catalyst 36 coated across the surfaces thereof, and the oxygen storage components 38 coated across the SCR catalyst 36 in the rear zone RZ alone.

Referring back to FIG. 2, the system 10 further includes an upstream oxygen sensor 20 disposed in the exhaust system 14 in front of or upstream of the modified SCR catalyst 18, and a downstream oxygen sensor 22 disposed in the exhaust system 14 after or downstream from the modified SCR catalyst 18. Each of the oxygen sensors 20, 22 detects rich (excess fuel) and lean (excess oxygen) mixtures in the exhaust gas. More particularly, the upstream oxygen sensor 20 detects rich and lean mixtures in the exhaust gas prior to the exhaust gas reaction with the modified SCR catalyst 18, and the downstream oxygen sensor 22 detects rich and lean mixtures in the exhaust gas after the exhaust gas reaction with the modified SCR catalyst 18. In one example, the mechanism in the sensors 20, 22 involves a chemical reaction that generates a voltage, and the voltage data is transmitted to an engine control module 24 for analysis. For example, the engine control module 24 can analyze the voltage to determine if the mixture is rich or lean, and can then adjust the amount of fuel entering the engine 12 in a suitable manner.

As such, the system 10 also includes the engine control module 24, which is in communication with the engine 12 and both of the oxygen sensors 20, 22. The engine control module 24 includes a processing unit 26, memory 28, inputs 30, outputs 32, communication lines and other hardware and software (not shown) to control the engine 12 and related tasks. The engine control module 24 may control tasks such as maintaining a fuel-to-air ratio, controlling exhaust-gas recirculation, and onboard diagnostics.

As previously mentioned, the engine control module 24 is in communication with both of the oxygen sensors 20, 22. The processing unit 26 receives upstream and downstream oxygen sensor data (e.g., voltage data) and processes such data to monitor the health and lifespan of the modified SCR catalyst 18. The processing unit 26 may be a micro controller, a controller, a microprocessor, and/or a host processor. In another example, the processing unit 26 is an application specific integrated circuit (ASIC). In an example, the processing unit 26 includes software programs having computer readable code/machine readable instructions to perform on-board diagnostics of the modified SCR catalyst 18. For instance, the software programs may include computer readable code/machine readable instructions for monitoring the received sensor data, for detecting a change in the oxygen storage capacity based upon the received sensor data, for determining whether the detected change exceeds a threshold, and for triggering an alarm or warning if the detected change exceeds the threshold.

In one example, the engine control module 24 includes machine readable instructions for determining or calculating the oxygen storage capacity of the oxygen storage components 38 in the modified SCR catalyst. This may be accomplished using the data received from the sensors 20, 22. In one example, the oxygen storage capacity is determined by monitoring the voltage data for the upstream oxygen sensor 20 and downstream oxygen sensor 22. The rich/lean or lean/rich transition can be determined from the voltage data. When performing on-board diagnostics of the modified SCR catalyst, the engine 12 may be directed (by the engine control module 24) to saturate the modified SCR catalyst with a rich exhaust gas feedstream (i.e., a rich mixture) for a predetermined time period (e.g., 5 seconds to 10 seconds) before switching to a lean exhaust gas feedstream (i.e., a lean mixture). After switching to the lean mixture, the time between the switching of the upstream sensor 20 and downstream sensor 22 can be measured. This measurement provides an assessment of the oxygen storage capacity of the modified SCR catalyst 18. The measured storage capacity can then be compared to threshold values previously established and correlated to the specific modified SCR catalyst 18. These values may range from 1 second to 30 seconds, depending on the size and state of the catalyst 18.

Depending, at least in part, on the type of oxygen storage modification used for the modified SCR catalyst 18, the aged oxygen storage capacity of the modified catalyst 18 will change from the original state. This change is then monitored. The change level exceeding a specific threshold can be an indication of poor catalyst health. For instance, in one example, the switch time delay between the upstream sensor 20 and the downstream sensor 22 may increase from 5 seconds to 15 seconds. Previously established values can be stored within the engine control module 24 for comparison purposes. If the previously established maximum value for a compromised (e.g., degraded) modified catalyst 18 is 12 seconds, then the measured catalyst in this example can be determined to have inadequate performance.

Another method that can be employed to provide an indication of oxygen storage capacity is to monitor the frequency of air-to-fuel ratio switching from the upstream sensor 20 and the downstream sensor 22. The engine control module 24 can modulate the engine air/fuel ratio at about 0.1 hertz to about 1 hertz, using air/fuel ratios that are approximately 10% rich and 10% lean of stoichiometry. The frequency of rich and lean air/fuel ratio excursions of the upstream sensor 20 and downstream sensor 22 can be measured. The downstream sensor 22 will normally have a lower frequency of switching between rich and lean air-to-fuel ratios. The switching frequency of the downstream sensor 22 will change as the oxygen storage capacity of the modified SCR catalyst 18 changes. For instance, with a very low level of oxygen storage capacity, the downstream sensor 22 will have a switching frequency that is nearly the same as the upstream sensor 20. Conversely, a high level of oxygen storage capacity within the modified SCR catalyst 18 will serve to dampen the air-to-fuel ratio excursions and produce a relatively slow switching of air-to-fuel ratio for the downstream sensor 22. The ratio of switching frequencies of the upstream sensor 20 versus the downstream sensor 22 can then be compared to threshold values previously established for minimally acceptable modified catalysts 18. Once the switching ratio exceeds a threshold value, the engine control module 24 can indicate a fault with the modified SCR catalyst 18.

In response to recognizing the deterioration in the modified SCR catalyst 18, the engine control module 24 can trigger an in-vehicle alarm 34. The alarm 34 is an in-vehicle alert that informs an in-vehicle user that the modified SCR catalyst 18 should be changed. The alarm 34 may be a visual alarm (e.g., a light or a visual display). In one example, the alarm 34 includes an in-vehicle icon that is lit up when triggered, similar to the alarm that is generated when low levels of fuel are detected. A visual alarm may be displayed on the dashboard or on an in-vehicle display.

It is to be understood that when the on-board diagnostics reveal that the oxygen storage capacity and the modified SCR catalyst 18 performance is acceptable, the system 10 will continue to operate without activating the alarm 34. In one example, on-board diagnostics will be performed at regularly scheduled intervals (as programmed in the engine control module 24).

It is to be further understood that the system 10 may also include other sensors, transducers or the like that are in communication with the engine control module 24 through the inputs 30 and outputs 32 to further carry out a method as described herein.

To further illustrate the present disclosure, an example is given herein. It is to be understood that this example is provided for illustrative purposes and is not to be construed as limiting the scope of the disclosure.

### EXAMPLE

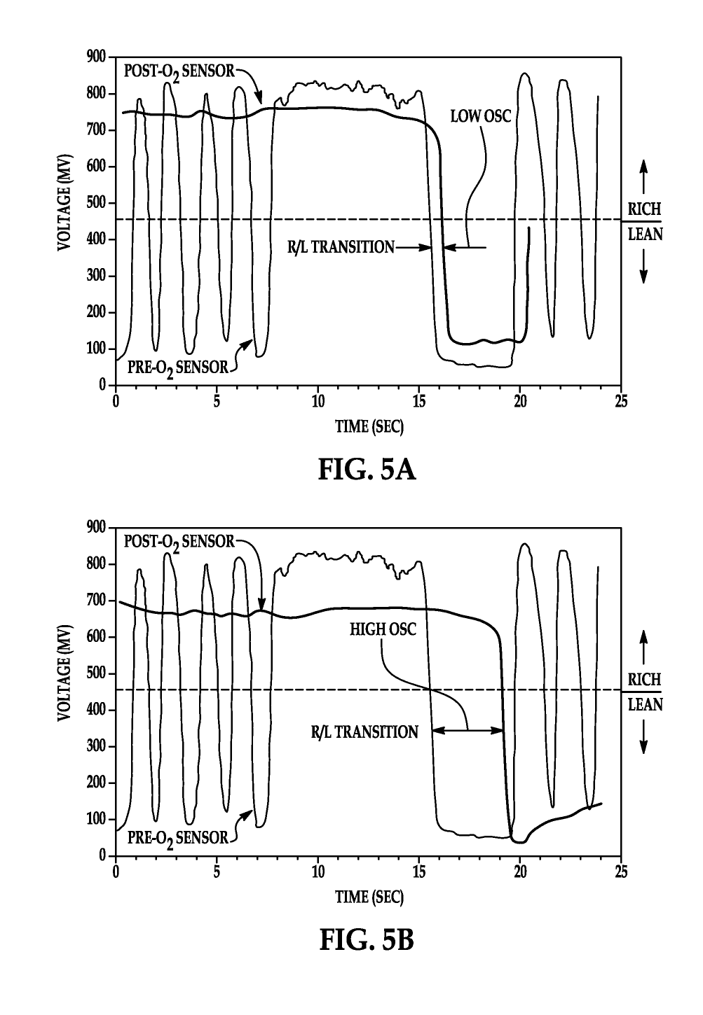

FIGS. 5A and 5B illustrate a prophetic example of the on-board diagnostics method disclosed herein. FIG. 5A illustrates oxygen sensor data from the upstream and downstream sensors 20, 22 that is received at the engine control module 24 during a first diagnostics check, and FIG. 5B illustrates oxygen sensor data from the upstream and downstream sensors 20, 22 that is received at the engine control module 24 during a subsequent diagnostics check. The oxygen sensor data that is received is the voltage and the time at which the voltage is measured.

When performing the first on-board diagnostics of the modified SCR catalyst, the engine control module 24 transmits signals to the engine 12 to operate in a particular manner. In this example, the engine operates where the average fuel-to-air ratio is stoichiometric, and thus the voltage data for the upstream oxygen sensor 20 regularly toggles between rich mixtures and lean mixtures for the first 8 seconds of the diagnostics. Then, the modified SCR catalyst is saturated with a rich exhaust gas feedstream from the 8 second mark to about the 15 second mark before switching to a lean mixture. At 15 seconds, the mixture is switched from rich to lean. As illustrated in FIG. 5A, the upstream sensor recognizes the switch from rich to lean immediately. There is a relatively short delay in the recognition of the rich to lean transition by the downstream sensor. The delay is approximately 1 second. This relatively short delay indicates that the oxygen storage capacity of the modified SCR catalyst is low, and that the modified SCR catalyst is in good health (i.e., is functioning properly).

When performing the subsequent on-board diagnostics of the modified SCR catalyst, the engine control module 24 transmits signals to the engine 12 to operate in a particular manner. Similar to FIG. 5A, the engine operates where the average fuel-to-air ratio is stoichiometric, and thus the voltage data for the upstream oxygen sensor 20 regularly toggles between rich mixtures and lean mixtures for the first 8 seconds of the diagnostics. Then, the modified SCR catalyst is saturated with a rich exhaust gas feedstream from the 8 second mark to about the 15 second mark before switching to a lean mixture. At 15 seconds, the mixture is switched from rich to lean. As illustrated in FIG. 5B, the upstream sensor recognizes the switch from rich to lean immediately. In this example, the delay in the recognition of the rich to lean transition by the downstream sensor is more than the delay recorded in FIG. 5A. In this example, the delay is more than 4 seconds.

The change in the recognition delay is recognized by the engine control module 24. The change is calculated by the engine control module 24, and is compared to a preset threshold value for the particular system 10. In this example, the preset threshold value may be 3 seconds. The change is slightly over the 3 second threshold, and thus the engine control module 24 is programmed to recognize that the oxygen storage capacity has increased and that the SCR catalyst should be changed.

While several examples have been described in detail, it will be apparent to those skilled in the art that the disclosed embodiments may be modified. Therefore, the foregoing description is to be considered non-limiting.

1. An on-board diagnostics system for a vehicle having an engine and an exhaust system, the system comprising:
a modified selective catalytic reduction catalyst coupled to the engine via the exhaust system, the modified selective catalytic reduction catalyst including oxygen storage components;
an upstream oxygen sensor disposed in the exhaust system upstream of the modified selective catalytic reduction catalyst;
a downstream oxygen sensor disposed in the exhaust system downstream from the modified selective catalytic reduction catalyst; and
an engine control module that receives data from the upstream and downstream oxygen sensors and determines a lifespan of the modified selective catalytic reduction catalyst based upon the data from the upstream and downstream oxygen sensors.

2. The on-board diagnostics system as defined in claim 1 wherein a selective catalytic reduction catalyst of the modified selective catalytic reduction catalyst is chosen from an oxide-based catalyst and a molecular sieve.

3. The on-board diagnostics system as defined in claim 1 wherein the oxygen storage components are chosen from CeO₂, metal promoted CeO₂, CeO₂ on an alumina support, and zirconia stabilized CeO₂.

4. The on-board diagnostics system as defined in claim 3 wherein the metal promoted CeO₂ includes a trace amount of a metal chosen from copper, iron, tungsten, nickel, and mixtures thereof.

5. The on-board diagnostics system as defined in claim 4 wherein the trace amount of the metal is equal to or less than 20 g/ft³.

6. The on-board diagnostics system as defined in claim 3 wherein the metal promoted CeO₂ has a surface area greater than 100 m²/g.

7. The on-board diagnostics system as defined in claim 1 wherein the oxygen storage components exhibit a change in oxygen storage capacity at conditions to which the modified selective catalytic reduction catalyst is exposed, and wherein the oxygen storage capacity changes at a rate equal to or faster than a rate of degradation of a selective catalytic reduction catalyst in the modified selective catalytic reduction catalyst.

8. The on-board diagnostics system as defined in claim 1 wherein the data includes upstream and downstream oxygen sensor data, and wherein the engine control module includes machine readable instructions for:
detecting a change in oxygen storage capacity of the oxygen storage components; and
determining whether the change in the oxygen storage capacity exceeds a threshold value.

9. The on-board diagnostics system as defined in claim 8, further comprising an in-vehicle alarm operatively connected to the engine control module, wherein the engine control module activates the in-vehicle alarm when the change in the oxygen storage capacity exceeds the threshold value.

10. An on-board diagnostics method for a vehicle having an engine and an exhaust system, the method comprising:
determining, via an engine control module, oxygen storage capacity of a modified selective catalytic reduction catalyst including oxygen storage components embedded therein using signal data from an upstream oxygen sensor disposed in the exhaust system upstream of the modified selective catalytic reduction catalyst and a downstream oxygen sensor disposed in the exhaust system downstream of the modified selective catalytic reduction catalyst;
detecting, via the engine control module, a change in the oxygen storage capacity of the modified selective catalytic reduction catalyst; and
determining, via the engine control module, whether the change in the oxygen storage capacity exceeds a threshold value.

11. The on-board diagnostics method as defined in claim 10, further comprising:
determining that the change in the oxygen storage capacity exceeds the threshold value; and
triggering an in-vehicle alarm that indicates that the modified selective catalytic reduction catalyst should be changed.

12. The on-board diagnostics method as defined in claim 10, further comprising:
determining that the change the oxygen storage capacity is at or below the threshold value; and
continuing to monitor upstream and downstream oxygen sensor signal data.

13. An on-board diagnostics method, comprising:
correlating an oxygen storage capacity of a modified selective catalytic reduction catalyst with a thermal degradation of a selective catalytic reduction catalyst in the modified selective catalytic reduction catalyst; and
determining when a change in the oxygen storage capacity exceeds a threshold, thereby recognizing degradation of the selective catalytic reduction catalyst in the modified selective catalytic reduction catalyst.

14. A modified selective catalytic reduction catalyst, comprising:
a selective catalytic reduction catalyst chosen from an oxide-based catalyst and a molecular sieve; and
oxygen storage components associated with the selective catalytic reduction catalyst.

15. The modified selective catalytic reduction catalyst as defined in claim 14 wherein the oxygen storage components are mixed with the selective catalytic reduction catalyst.

16. The modified selective catalytic reduction catalyst as defined in claim 14 wherein the oxygen storage components are formed as a layer on the selective catalytic reduction catalyst.

17. The modified selective catalytic reduction catalyst as defined in claim 14 wherein the oxygen storage components and the selective catalytic reduction catalyst are zone coated on a support body.

18. The modified selective catalytic reduction catalyst as defined in claim 14 wherein the oxygen storage components are chosen from CeO₂, metal promoted CeO₂, CeO₂ on an alumina support, and zirconia stabilized CeO₂.

19. The modified selective catalytic reduction catalyst as defined in claim 18 wherein the metal promoted CeO₂ includes a trace amount of a metal chosen from copper, iron, tungsten, nickel, and mixtures thereof.

20. The modified selective catalytic reduction catalyst as defined in claim 19 wherein the trace amount of the metal is equal to or less than 20 g/ft³.
